(19) United States
(12) Patent Application Publication
(10) Pub. No.: US 2022/0345497 A1
(43) Pub. Date: Oct. 27, 2022

(54) ADAPTIVE SAMPLING OF SECURITY POLICY VIOLATIONS

(71) Applicant: Tala Security, Inc., Fremont, CA (US)

(72) Inventors: Sandeep Bhatkar, Sunnyvale, CA (US); Hemant Puri, Fremont, CA (US); Aanand Krishnan, Fremont, CA (US); Swapnil Bhalode, Fremont, CA (US); Siddhesh Yawalkar, Sunnyvale, CA (US)

(21) Appl. No.: 17/729,852

(22) Filed: Apr. 26, 2022

Related U.S. Application Data
(60) Provisional application No. 63/179,979, filed on Apr. 26, 2021.

(51) Int. Cl. H04L 9/40

(52) U.S. Cl. CPC H04L 63/20

(57) ABSTRACT

Techniques to facilitate adaptive sampling of security policy violations are disclosed herein. In at least one implementation, a variable sampling rate for sampling a fixed amount of security policy violation reports per unit time based on a violation rate is determined. The variable sampling rate is applied to sample the fixed amount of the security policy violation reports per unit time. When the violation rate exceeds a threshold, the variable sampling rate is switched to a fixed sampling rate for sampling a variable amount of the security policy violation reports per unit time. The fixed sampling rate is applied to sample the variable amount of the security policy violation reports per unit time.

### RELATED APPLICATIONS

This application claims the benefit of, and priority to, U.S. Provisional Patent Application No. 63/179,979, entitled “An adaptive sampling-based method to improve the effectiveness of Content Security Policy”, filed on Apr. 26, 2021, which is hereby incorporated by reference in its entirety for all purposes.

### TECHNICAL BACKGROUND

Modern web applications integrate code and other resources from dozens of third-party service providers, including content delivery networks (CDNs) and third-party JavaScript libraries. A significant portion of this content comprises executable scripts with direct security impact on a website. For example, recent breaches of user data on many popular websites have been attributed to compromised third-party JavaScript files.

Advanced web architectures typically rely heavily on JavaScript and enabling third-party code to perform client-side network requests. These innovations are built on client-heavy frameworks that leverage the processing power of the client device to enable the execution of code directly on the web browser. Today, it is not uncommon for a majority of the code executing and rendering on a client browser to come from such integrations. All of these software integrations provide avenues for potential vulnerabilities. Web browser standards such as content security policy (CSP) can help to prevent exploitation of such vulnerabilities.

Cybercriminals often attack websites for malicious purposes such as stealing data, site defacement, cryptojacking, and clickjacking. CSP is a web standard that is designed to block techniques such as cross-site scripting (XSS) and code injection used by these attacks. To enable CSP, a web server is configured to return a CSP response header with a policy that encodes valid web application behavior. This allows a web browser to block and report any behavior that does not conform to the policy.

Unfortunately, it is difficult to build an accurate policy for an application that changes frequently, which can result in a large number of false positives where valid behaviors cause violations. False positives may be mitigated with a permissive policy, but this can lead to false negatives where attacks go undetected. When the policy is violated, a report may be sent to a receiving server specified in the policy, thereby enabling website security administrators to process and manage the violations. The security response could involve incorporating false positives to refine the policy, and more importantly, detecting the incidents of actual attacks.

### Overview

Techniques to facilitate adaptive sampling of security policy violations are disclosed herein. In at least one implementation, a variable sampling rate for sampling a fixed amount of security policy violation reports per unit time based on a violation rate is determined. The variable sampling rate is applied to sample the fixed amount of the security policy violation reports per unit time. When the violation rate exceeds a threshold, the variable sampling rate is switched to a fixed sampling rate for sampling a variable amount of the security policy violation reports per unit time. The fixed sampling rate is applied to sample the variable amount of the security policy violation reports per unit time.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates a communication system in an exemplary embodiment.

FIG. 2 is a sequence diagram that illustrates an operation of a communication system in an exemplary embodiment.

FIG. 3 is a sequence diagram that illustrates an operation of a communication system in an exemplary embodiment.

FIG. 4 is a sequence diagram that illustrates an operation of a communication system in an exemplary embodiment.

FIG. 5 is a chart diagram that illustrates the relationship between sampling rate and violation rate in an exemplary embodiment.

FIG. 6 is a chart diagram that illustrates the relationship between sampling rate and violation rate in an exemplary embodiment.

FIG. 7 is a flow diagram that illustrates an operation of the communication system in an exemplary embodiment.

FIG. 8 is a block diagram that illustrates a computing system in an exemplary embodiment.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

Modern web applications integrate code, scripts, and other resources from many different third-party service providers, including content delivery networks (CDNs) and third-party JavaScript libraries. For example, JavaScript code can be loaded as an inline script, or through a uniform resource locator (URL) to an external script source. Content security policy (CSP) is a widely supported web standard for preventing cross-site scripting (XSS) and code injection attacks. CSP provides a mechanism for website owners to specify the origins of allowed executable scripts and other code on their website, such as JavaScript files, images, and other web resources. For example, a security policy may be specified by providing an inventory that lists all of the trusted sources that host the various resources of the web site, such as the domain names or URLs of the valid third-party hosts from which the client browser can download legitimate JavaScript files, fonts, images, embeddable objects, and other web content. This list of valid resources is typically provided as a security policy in a CSP response header that is received by a user's web browser when the user visits a website. The client web browser analyzes the CSP header and verifies that the web application is behaving according to the security policy specified in the CSP header, meaning that the web application is only accessing the resources from the valid origins listed in the policy. If the web browser determines that the web application is attempting to load any resource from a source that is not specified in the CSP header, then this action is blocked and identified as a violation of the policy.

When a violation of the policy occurs, the CSP header also has a reporting directive that may be utilized to specify an endpoint where the violation should be reported, such as a URL of a submission server. This reporting directive may be utilized by security administrators of a website in order to investigate violation reports to determine the cause of a violation that occurs in the browser of a user. For example, violations of the security policy can occur because the policy was not specified correctly and a valid resource was blocked, creating a false positive, or because the violation was actually an instance of an attack. Accordingly, when a web browser identifies a violation of the policy and the ‘report-to’ directive is provided in the CSP header, the browser creates a violation report that specifies the resource that triggered the violation along with contextual information and other details of the violation, and then submits the violation report to the specified submission server. Security administrators then typically review the violation reports received at the submission server and take appropriate action. For example, if the violation is determined to be a false positive, where a valid resource was blocked because the policy was inaccurate, then the policy would need to be updated to correct this misclassification of violation. However, if the violation is identified as a case of an actual attack, then the administrator may simply note that an attack was successfully prevented by the security policy, and no changes are necessary because the policy is working effectively to thwart the attacker.

Although this CSP violation reporting mechanism provides an effective way to monitor and analyze the policy violations that are occurring at the client-side browsers, there are times when the number of violations being reported is too large for the computing systems and the security operations team to process and manage in a timely manner. For example, a JavaScript file may trigger a false positive because the policy is flawed and the valid origin of the file is not correctly specified in the policy, which could result in an unmanageable number of violation reports because the violation is reported by the browser of every user who accesses the webpage. In another example, a brute-force attack approach could result in an attack being launched against all users each time a page is loaded, resulting in a violation report from every user for every page load as well. When the volume of the violations reported to the submission server is too high, the processing capacity of the security operations team may become overloaded, and it could take a long time to investigate and determine whether this excessive report volume is a case of false positives or an actual attack.

In order to avoid impacting the effectiveness and efficiency of the security administrators with an overwhelming number of violations, the volume of CSP violation reports can be managed by limiting the amount of violation reports to a smaller sample. One technique to reduce the volume of CSP violation reports could be implemented by a web server throttling a fixed percentage of web requests that receive CSP response headers that specify a submission server in the ‘report-to’ reporting directive. Under this strategy, when the web server inserts a CSP response header in the response to a web request, the decision of whether or not to include the ‘report-to’ directive and specify a submission server may be governed by a predetermined fixed rate. For example, if a fixed rate of fifty percent were selected, then the ‘report-to’ directive would be included in roughly half of the CSP response headers, and any violations would be submitted to the specified submission server, while the other half of the response headers would not specify a server, in which case the browsers will still enforce the policy but will not report any violations. However, because the traffic volume on a website is highly unpredictable, simply using such a fixed rate for sampling violation reports is not adequate in several real-world scenarios. For example, when the traffic volume is very high, there is still a possibility that the number of violation reports would be too large for a security operations team to process them all in a timely manner. Conversely, when the traffic volume is low during off-peak hours, using a fixed rate would unnecessarily cause the security administrators to miss out on a fraction of reports, even though they would likely have the capacity to handle all of them. The blind spots created during such periods automatically increase the chance of success of an attack. The present disclosure addresses these issues by providing guarantees on the detection time, while minimizing the processing cost.

The techniques disclosed herein describe an adaptive sampling algorithm that limits the number of violation reports while still providing fine-grained and continuous visibility that is necessary for policy refinement and timely detection of attacks. In some implementations, a fixed sampling budget is created for the number of violations to sample in a time period, which may be based on the processing capacity in some examples, such as the amount of reports that the computing systems and security administrators are able to process and manage in a timely manner. In at least one implementation, the sampling budget can be achieved by producing a traffic-dependent variable sampling rate such that approximately the same number of samples is generated per unit time, providing uniform visibility into the violations across time.

The sampling budget has an impact on the expected detection time. Most existing attacks use a brute-force strategy, attempting to victimize every user over every web transaction. Such attacks can be quickly detected using a relatively small sampling budget. For example, with a sampling budget of sixty samples per hour, a brute-force attack can be detected in one minute on average. However, sampling-aware attacks may employ a low and slow strategy to bypass sampling-based detection, where not every user transaction is targeted. Instead, the attack is executed infrequently in an attempt to remain undetected. The detection time for this type of sampling-aware attack is inversely proportional to the sampling budget. A lower budget will result in a lower sampling rate, and consequently will cause the detection to be slower. The budget can be increased for faster detection, but this will also increase the processing cost. Thus, the adaptive sampling strategy disclosed herein provides a good trade-off between the processing cost and the detection time by employing a budget-based variable sampling rate up to a threshold violation rate, which typically covers a large majority of the traffic conditions. On rare occasions when the violation rate crosses the threshold, the sampling strategy is switched to a fixed rate so that the detection time remains bounded, but with an increased processing cost because the sampling budget effectively increases with the violation rate.

Beneficially, the adaptive sampling techniques disclosed herein provide for uniform visibility of policy violations and facilitate management and response in a timely and effective manner. A primary goal of adaptive sampling is to minimize the number of violation reports so that security administrators are able to analyze the violations and respond in a predictable time frame. Sampling based on a fixed rate does not serve this goal because the number of samples varies in proportion to the number of violations reported. However, adaptive sampling of security policy violation reports achieves an improvement in both utility and security by providing continuous and uniform visibility across time needed to detect attacks in a timely manner, while also reducing the processing cost associated with examining and responding to the violations.

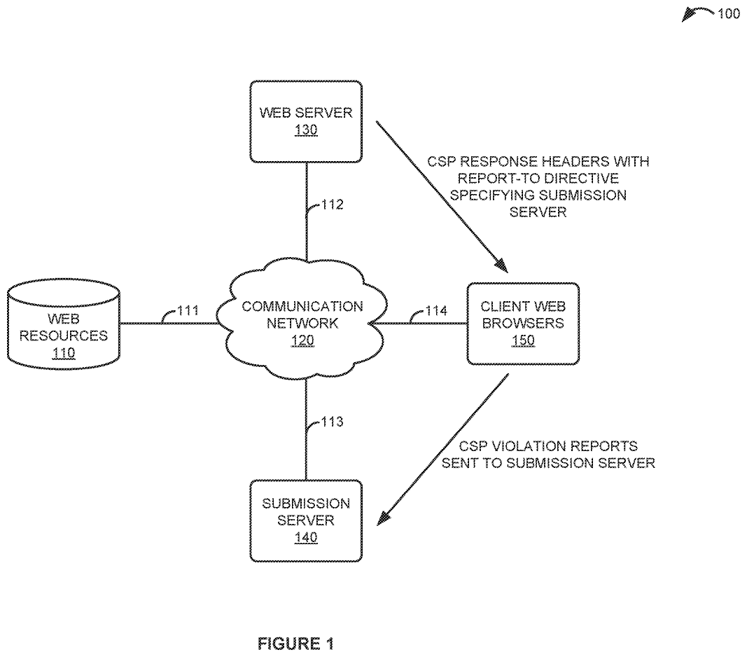

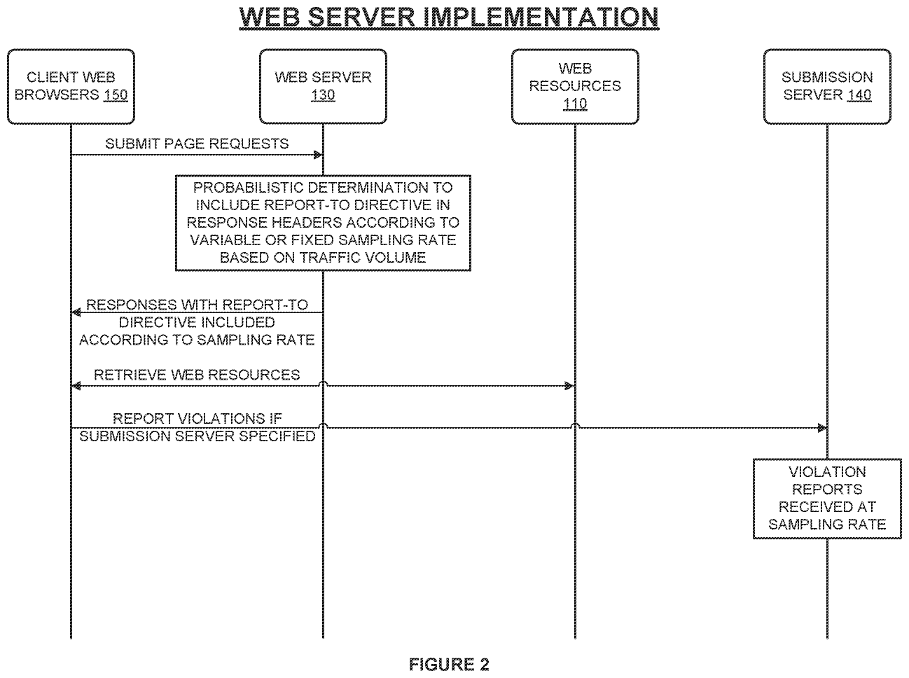

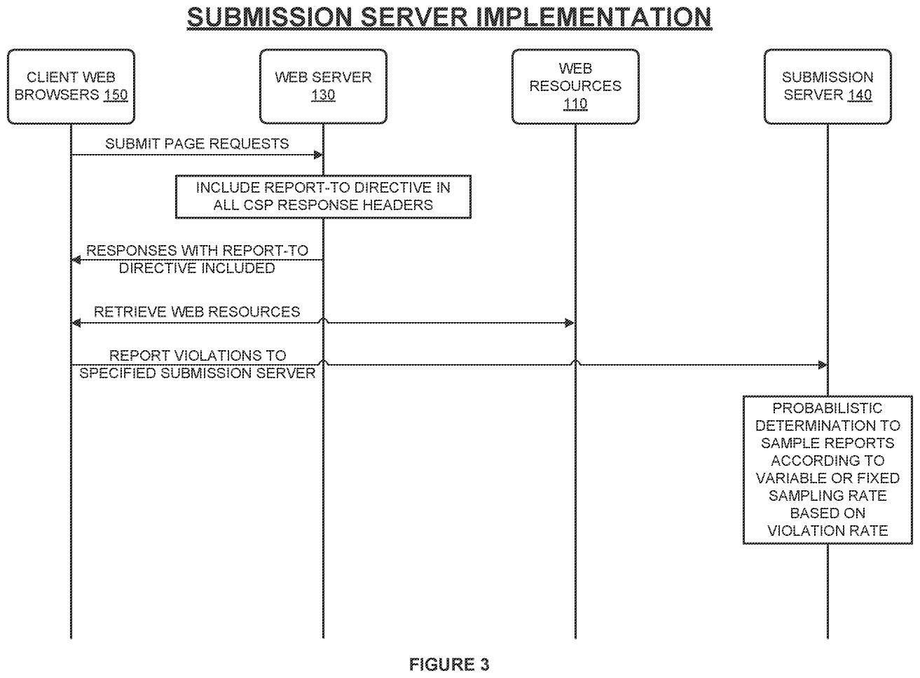

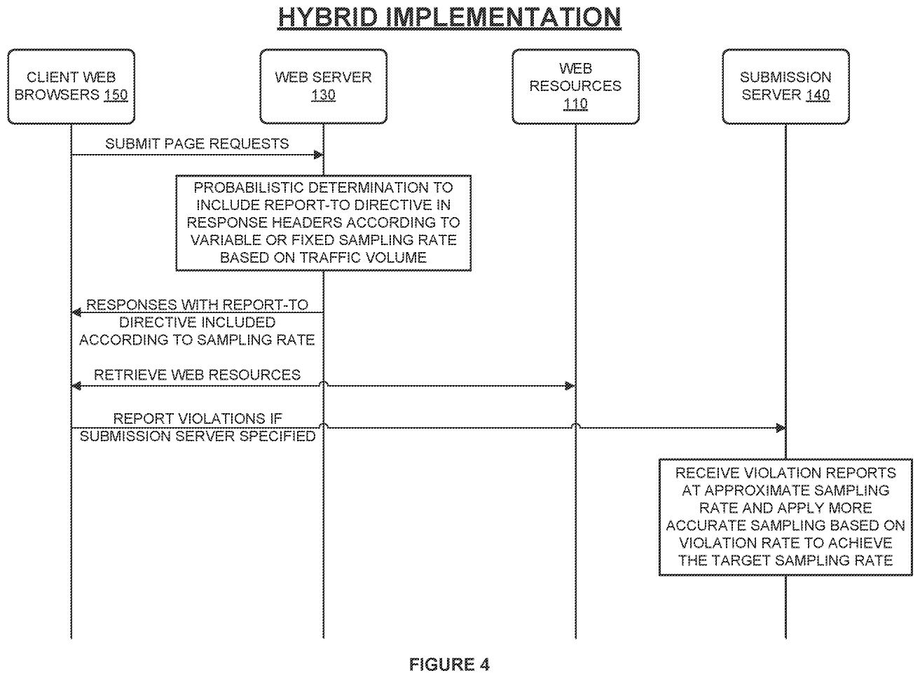

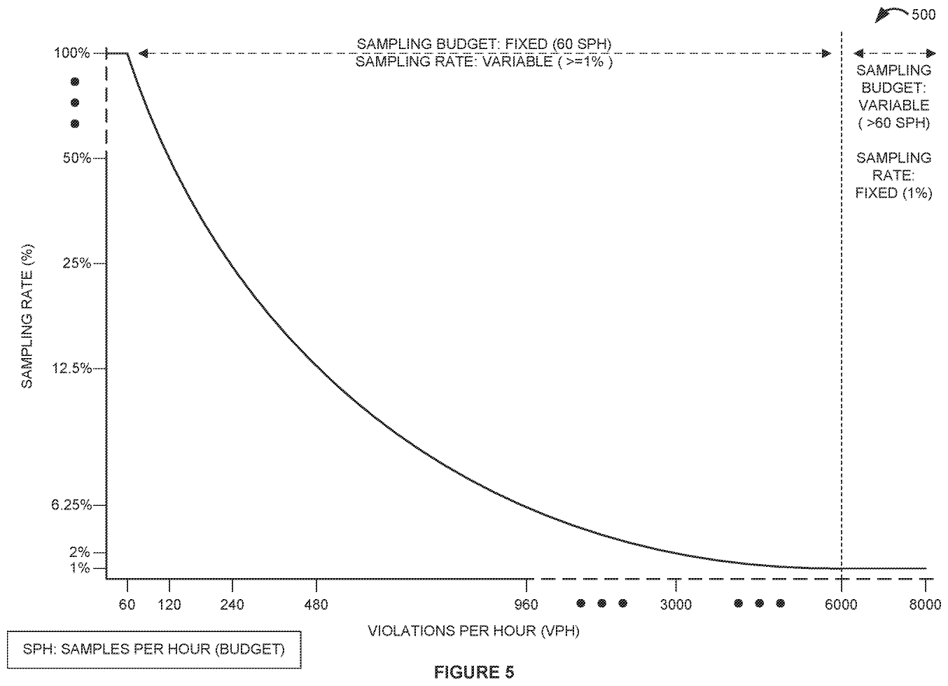

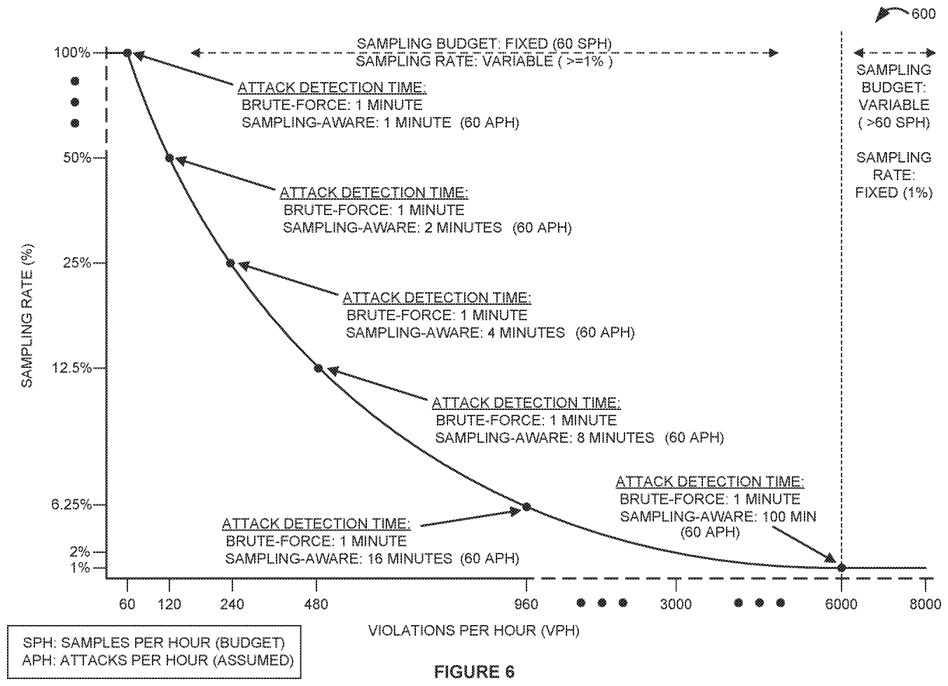

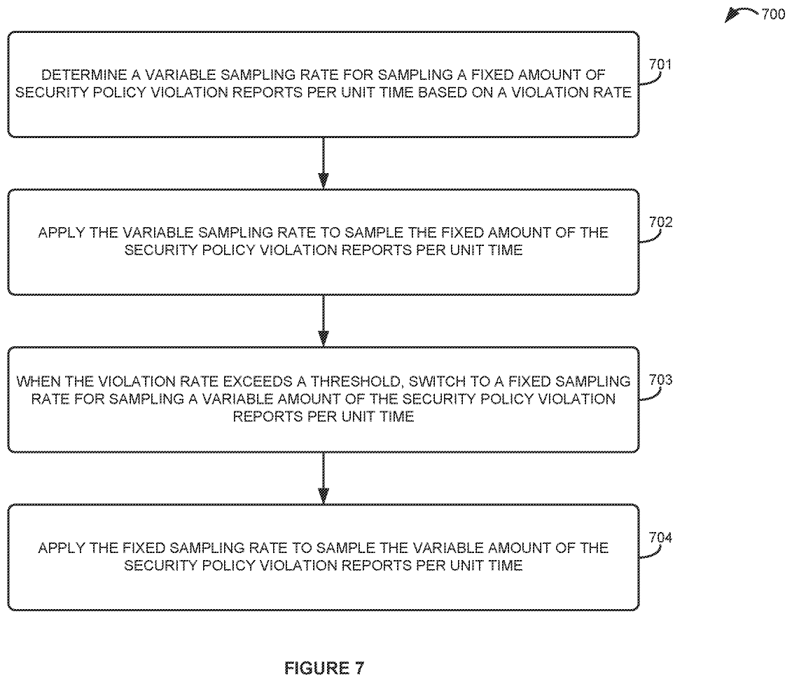

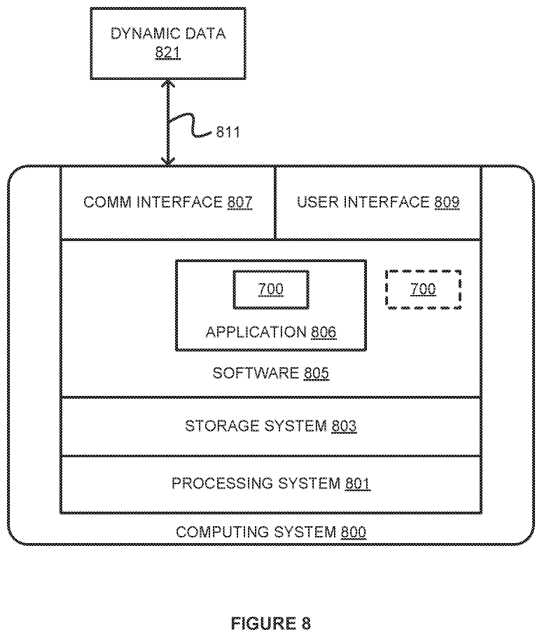

Referring now to the drawings, FIG. 1 illustrates a communication system that may employ the adaptive sampling techniques disclosed herein. FIG. 2 illustrates an implementation of adaptive sampling at a web server, FIG. 3 illustrates an implementation of adaptive sampling at a submission server, while FIG. 4 illustrates a hybrid implementation of adaptive sampling at both a web server and a submission server. FIGS. 5 and 6 are chart diagrams that graphically illustrate the relationship between sampling rate and violation rate and provide an example of variations in the sampling rate due to an adaptive sampling strategy. FIG. 7 is a flow diagram that illustrates an adaptive sampling process that may be performed by a computing system. Finally, FIG. 8 illustrates an exemplary computing system that may be used to perform any of the adaptive sampling processes and operational scenarios described herein.

Turning now to FIG. 1, a block diagram of communication system 100 is illustrated. Communication system 100 includes web resources 110, communication network 120, web server 130, submission server 140, and client web browsers 150. In some implementations, web resources 110 could comprise any resources used in the provision of a web application, such as scripts, code libraries, fonts, JavaScript files, images, and any other web application components, which may be stored on a database or some other data storage system that provides web resources 110 for a web application.

In operation, users operate various computing systems to execute client web browsers 150 to access a web application, such as a website provided by web server 130. In this example, the web application integrates web resources 110 from many different third-party service providers, including CDNs and third-party libraries. The client web browsers 150 submit page requests to web server 130 to access the various pages of the web application. In response to the page requests, web server 130 specifies a security policy in a CSP response header that lists all of the trusted sources that host web resources 110, such as the domain names or URLs of the valid third-party hosts from which the client web browsers 150 can download legitimate JavaScript files, fonts, images, embeddable objects, and other web content. In addition to the valid origins of web resources 110, the CSP response header may also include a reporting directive that can be utilized to specify an endpoint where a violation of the policy should be reported, such as a URL of submission server 140. In this example, when web server 130 responds to the page requests from client web browsers 150, some or all of the CSP response headers include a ‘report-to’ reporting directive that specifies submission server 140.

Upon receipt of the responses to the page requests, client web browsers 150 attempt to load web resources 110 to render the web application. As part of this process, the client web browsers 150 analyze the CSP response header and verify that the web application is behaving according to the security policy specified in the CSP header, meaning that the web application is only accessing web resources 110 from the valid origins listed in the policy. If the client web browsers 150 determine that the web application is attempting to load any web resource 110 from a source that is not specified in the CSP response header, then this action is blocked and identified as a violation of the policy. Further, any of the client web browsers 150 that had the ‘report-to’ directive included in the CSP response header will send out a CSP violation report to the specified submission server 140.

However, although this CSP violation reporting mechanism enables security administrators to monitor and analyze the policy violations that are occurring at the client web browsers 150, there may be instances when the number of violations being reported is too large to process and manage in a timely manner. For example, if the security policy is inaccurate and the valid origin of one or more web resources 110 is not correctly specified in the policy, then a violation may be reported by the client web browsers 150 of every user who accesses the webpage. In another example, a brute-force attack launched against every user each time a page is loaded could result in a violation report from all client web browsers 150 as well. When the volume of the policy violations reported to submission server 140 is too large, the processing capacity of the security operations team may become overloaded, and it could take a long time to examine the reports and determine whether the high report volume is a case of false positive or an actual attack. In order to avoid negatively impacting the processing capacity of the security administrators with an excessive number of violations, the volume of CSP violation reports can be managed effectively by employing an adaptive sampling algorithm that limits the amount of violation reports to a smaller sample. An example of an adaptive sampling technique implemented on web server 130 will now be discussed with respect to FIG. 2.

FIG. 2 is a sequence diagram that illustrates an exemplary operation of an adaptive sampling algorithm implemented on web server 130. The techniques described below with respect to FIG. 2 could also be combined with operation 700 of FIG. 7 in some implementations.

In this example, adaptive sampling of CSP violation reports is implemented at web server 130. The adaptive sampling algorithm reduces the CSP violation report volume while still providing continuous and uniform visibility across time, which is necessary to detect and respond to attacks in a timely and efficient manner.

Initially, client web browsers 150 submit page requests to web server 130. In response to the page requests, web server 130 implements adaptive sampling of CSP violation reports by probabilistically determining whether or not to include the ‘report-to’ reporting directive in the CSP response headers to specify an endpoint where a violation of the policy should be reported, such as the URL of submission server 140 in this example. As part of this determination, web server 130 identifies whether a variable sampling rate or a fixed sampling rate should be applied based on the traffic volume. In particular, when the traffic volume is below a threshold level, web server 130 applies a variable sampling rate, but when the traffic volume exceeds the threshold, a fixed sampling rate is applied.

The variable sampling rate is determined by first creating a fixed sampling budget defined as a number of sampled violations per unit time. The sampling budget can be achieved by producing a traffic-dependent variable sampling rate such that approximately the same number of samples is generated per unit time, providing uniform visibility into the violations across time. To facilitate explanation, this example assumes a sampling budget of sixty samples per hour, but greater or fewer numbers of samples over different time intervals could also be used depending on the processing capacity of a security operations team and their equipment to analyze and handle the sampled violations.

In this example, to calculate the variable sampling rate, web server 130 implements an hour-long sliding window using minute-level granularity of violation counts. The variable sampling rate for the current minute is then calculated by the equation SR=min(1, B/V), where B is the sampling budget in samples per hour (SPH), and V is the number of violations in the past hour. When B is greater than or equal to V, the budget is surplus and the probability of sampling is one (always sample). Otherwise, when B is less than V, the violations are sampled with the probability B/V. This algorithm ensures uniform visibility into the violations across time. For example, a sampling budget of sixty samples per hour will yield one sample every minute per hour, as opposed to consuming all sixty samples in the first minute and then having no visibility for the next fifty nine minutes of the hour.

The above calculation refers to V as the number of violations in the past hour. However, because this adaptive sampling algorithm is implemented at web server 130 in this example, and since web server 130 cannot know in advance how many violations would result from a specific web request, the traffic rate (requests per hour) may be used to approximate the violation rate. For example, an assumption can be made that each request will result in at most one violation (i.e., V is the same as the traffic rate). However, if there are more violations per request, the excess volume could be handled at submission server 140, as described below with respect to FIGS. 3 and 4.

As discussed above, web server 130 implements adaptive sampling by probabilistically determining whether or not to include the ‘report-to’ directive in the CSP response headers according to the variable or fixed sampling rate based on the traffic volume. Web server 130 then transmits the responses with the ‘report-to’ directive included according to the variable or fixed sampling rate. After the client web browsers 150 receive the responses, they retrieve web resources 110 in order to render the web application. The client web browsers 150 then report any violations if submission server 140 was specified in the ‘report-to’ directive in the CSP response header, but those client web browsers 150 that did not have the ‘report-to’ directive included in their CSP response headers will not report any violations, thereby implementing the sampling rate. Submission server 140 therefore receives the violation reports at the appropriate sampling rate according to the current traffic volume, providing for uniform visibility of policy violations over time and effective management and response in a timely manner. An example of an adaptive sampling technique implemented on submission server 140 will now be discussed with respect to FIG. 3.

FIG. 3 is a sequence diagram that illustrates an exemplary operation of an adaptive sampling algorithm implemented on submission server 140. The techniques described below with respect to FIG. 3 could also be combined with operation 700 of FIG. 7 in some implementations.

In this example, adaptive sampling of CSP violation reports is implemented at submission server 140. Initially, client web browsers 150 submit page requests to web server 130. In response to the page requests, web server 130 is configured to include the ‘report-to’ reporting directive in all CSP response headers in response to every page request. Accordingly, web server 130 transmits responses with the ‘report-to’ directive included in every CSP response header to specify the URL of submission server 140 for reporting violations of the policy. After the client web browsers 150 receive the responses, they retrieve web resources 110 in order to render the web application. All of the client web browsers 150 will then report any policy violations to submission server 140 as specified in the ‘report-to’ directive in the CSP response header.

Submission server 140 therefore receives the violation reports from all of the client web browsers 150. Submission server 140 then implements adaptive sampling of the CSP violation reports by probabilistically determining whether or not to sample the violations according to a variable sampling rate or a fixed sampling rate based on the violation rate. When the violation rate is below a threshold level, submission server 140 applies a variable sampling rate, but applies a fixed sampling rate when the violation rate exceeds the threshold.

As discussed above, the variable sampling rate may be determined by creating a fixed sampling budget for the number of sampled violations per hour depending on how many violations the security administrators are able to effectively manage. The sampling budget can be achieved by producing a variable sampling rate based on the current violation rate such that approximately the same number of samples is generated per hour. In this example, submission server 140 calculates the variable sampling rate for the current minute by the equation SR=min(1, B/V), which ensures uniform visibility into the violations across time. Further, because submission server 140 is aware of the actual violation rate V based on the number of violations received from the client web browsers 150 in the past hour, submission server 140 is able to apply more precise control over the sampling rates than was possible with web server 130 approximating the violation rate from the traffic rate as discussed above with respect to FIG. 2. However, this implementation of applying adaptive sampling only at submission server 140 has greater resource requirements than implementing adaptive sampling at web server 130 because additional network bandwidth is needed to transmit all of the violation reports to submission server 140, and submission server 140 would require additional memory and computational resources to receive and process all of the violations before they are sampled. A good trade-off can be made between these two implementations by employing a hybrid approach where adaptive sampling is applied by web server 130 deciding whether or not to specify the ‘report-to’ directive in the CSP response headers in order to stem the violation report volume approximately, and then submission server 140 applying more accurate sampling to generate the desired sampling rate according to the adaptive sampling strategy. An example of this hybrid implementation where adaptive sampling is applied on both web server 130 and submission server 140 will now be discussed with respect to FIG. 4.

FIG. 4 is a sequence diagram that illustrates an exemplary operation of an adaptive sampling algorithm implemented on both web server 130 and submission server 140. The techniques described below with respect to FIG. 4 could also be combined with operation 700 of FIG. 7 in some implementations.

This example provides a hybrid implementation where adaptive sampling of CSP violation reports is implemented at both web server 130 and submission server 140. The adaptive sampling algorithm reduces the CSP violation report volume while still providing continuous and uniform visibility across time, which is necessary to detect and respond to attacks in a timely and efficient manner.

Initially, client web browsers 150 submit page requests to web server 130. In response to the page requests, web server 130 implements adaptive sampling of CSP violation reports by probabilistically determining whether or not to include the ‘report-to’ reporting directive in the CSP response headers according to a variable sampling rate or a fixed sampling rate based on the traffic volume. Web server 130 generally applies a variable sampling rate unless the traffic volume exceeds a threshold, in which case web server 130 switches to the fixed traffic rate. Web server 130 utilizes the traffic volume to approximate the violation rate by assuming that each request will result in at most one violation. However, if there are more violations per request, the excess volume can be handled at submission server 140 under this hybrid implementation.

Once web server 130 implements adaptive sampling according to the variable or fixed sampling rate based on the traffic volume, web server 130 then transmits the responses with the ‘report-to’ directive included according to the appropriate sampling rate. Client web browsers 150 receive the responses and retrieve web resources 110 in order to render the web application. The client web browsers 150 then report any violations if submission server 140 was specified in the ‘report-to’ directive in the CSP response header in order to approximate the sampling rate.

Submission server 140 thus receives the violation reports at the approximate sampling rate according to the current traffic volume. Submission server 140 then implements adaptive sampling of the CSP violation reports by probabilistically determining whether or not to sample the violations according to a variable sampling rate or the fixed sampling rate based on the violation rate. As discussed above, because submission server 140 can observe the actual violation rate, submission server 140 is able to apply more precise control over the sampling rates than the approximation provided by web server 130. Accordingly, once submission server 140 receives the violation reports at the approximate sampling rate, submission server 140 applies more accurate sampling based on the violation rate to achieve the target sampling rate according to the adaptive sampling strategy. Beneficially, this hybrid implementation of the adaptive sampling algorithm provides a good trade-off that delivers reduced violation reports along with fine-grained and continuous visibility necessary for policy refinement and timely detection of attacks.

Although the adaptive sampling technique discussed above provides uniform distribution of samples across time, it does not guarantee uniformity for other contexts associated with web requests such as page URLs and user agents, which could include a web browser type and/or version in some examples. An attacker can exploit this fact to evade detection. For instance, the attacker may restrict the attack to a less-frequently visited page, and since the probability of such a page getting sampled is lower as compared to other pages, it automatically increases the chance of success of the attack. To address this problem, the sampling budget could be specified per context, such as a combination of page URL and user agent. Other contexts associated with web requests could also be considered, such as geo-location, Internet protocol (IP) address, and any other contexts, but the number of potential contexts could be very high, and implementing the sliding window-based variable rate sampling may not be feasible due to high memory requirements. However, the memory issue can be overcome by using a hashing function. For example, an array of fixed size N may be used to store counters needed to generate the context-specific variable sampling rates. Then, for a web request (page URL, user agent), retrieve the counter values corresponding to the array index hash(page URL+user agent) mod N, where the operator+represents string concatenation, the operator mod represents modulo operation, and hash represents a string hashing function. Fixing the upper bound on the memory makes this approach practical, but it can lead to approximations that arise due to hash collisions. However, such approximations are tolerable and the above methodology still enables multiple different contexts to be considered. The goal is to achieve is a fixed and uniform budget per combination of different contexts. For example, sample sixty violations every hour (equivalent to one per minute for uniformity) per combination of webpage URL and user agent. In this manner, sampling-aware attacks that try to exploit blind spots created due to sampling can still be detected and thwarted. An example of variations in the sampling rate due to the adaptive sampling strategy will now be discussed with respect to the graphical representation of FIG. 5.

FIG. 5 is a chart diagram 500 that illustrates the relationship between sampling rate and violation rate in an exemplary embodiment. The techniques and concepts described below with respect to FIG. 5 could also be applied to or combined with operation 700 of FIG. 7 in some implementations.

Chart 500 provides an example of how the sampling rate varies based on the adaptive sampling strategy. The Y-axis of chart 500 indicates the sampling rate as a percentage from one to one hundred, while the X-axis indicates the violation rate in violations per hour (VPH). In this example, the sampling budget is fixed at 60 samples per hour (SPH) for sampling rates varying from 1% to 100%. A threshold violation rate is set at 6,000 VPH, as indicated by the dotted vertical line on chart 500. The sampling rate is therefore variable from 100% down to 1% for violation rates ranging from zero to 6,000 VPH, respectively. For violation rates greater than 6,000 VPH, the sampling rate is fixed at 1%, and the sampling budget becomes variable and unbounded as the violation rate increases.

As shown in chart 500, the effective sampling rate varies based on the violation rate. For example, using equation SR=min(1, B/V), where B is the sampling budget in SPH and V is the violation rate in VPH, a sampling rate of 100% is achieved for all violation rates less than or equal to 60 VPH, given the sampling budget of 60 SPH. The sampling rate drops to 50% for a violation rate of 120 VPH, 25% for a violation rate of 240 VPH, 12.5% for a violation rate of 480 VPH, 6.25% for a violation rate of 960 VPH, 2% for a violation rate of 3,000 VPH, and 1% for a violation rate of 6,000 VPH. The effect on the attack detection time for each of these different sampling rates will now be discussed with respect to FIG. 6.

FIG. 6 is a chart diagram 600 that illustrates the relationship between sampling rate and violation rate in an exemplary embodiment. The techniques and concepts described below with respect to FIG. 6 could also be applied to or combined with operation 700 of FIG. 7 in some implementations.

Chart 600 is identical to chart 500 of FIG. 5, and provides an example of how the sampling rate varies based on the adaptive sampling strategy. In this example, a worst-case sampling-aware attack rate is assumed to be 60 attacks per hour (APH). From an attacker's perspective, a faster attack rate may not work because it would be faster to detect, and a slower attack would also be undesirable because the attacker cannot steal very much data in a reasonable time period. For the detection purpose, the sampling budget is assumed to be 60 SPH, which may be determined based on the processing capacity required to effective analyze and process this number of samples. A sampling budget of 60 SPH enables the detection of any brute-force attack in one minute, and detection of sampling-aware attacks in less than one hundred minutes on an average for a violation rate up to 6,000 VPH. When the violation rate exceeds this threshold, it will take longer than one hundred minutes to detect the sampling-aware attack. Therefore, if we choose to bind the detection time to one hundred minutes for such a high violation rate, the variable sampling rate needs to switch to fixed rate sampling (1%) at the cost of extra processing load.

The sampling budget has an impact on the expected detection time. Most existing attacks use a brute-force strategy, trying to victimize every user over every web transaction. Such attacks can be quickly detected using a small sampling budget. For example, with a sampling budget of 60 SPH, a brute-force attack can be detected on an average in one minute for all violation rates up to 6,000 VPH. However, sampling-aware attacks may employ a low and slow strategy to bypass sampling-based detection, where not every user transaction is targeted. Instead, the attack is executed infrequently in an attempt to stay under the radar and remain undetected. The detection time for this kind of sampling-aware attack is (AR×SR)⁻¹ hours, where SR is the sampling rate and AR is the attack rate in attacks per hour (APH). For instance, with AR=60 APH, and SR=0.01 (1%), the detection time would be 1.67 hours (one hundred minutes).

The effective sampling rate varies based on the violation rate. For a violation rate under 60 VPH, the sampling rate is 100% and all the attacks can be detected in one minute on average. For violation rates ranging from 60 VPH to 6,000 VPH, the sampling rate drops from 100% to 1%, causing the average detection time of the sampling-aware attacks to vary from one to one hundred minutes. For example, assuming an attack rate of 60 APH, a violation rate of 120 VPH can be detected in two minutes, a violation rate of 240 VPH can be detected in four minutes, a violation rate of 480 VPH can be detected in eight minutes, a violation rate of 960 VPH can be detected in sixteen minutes, a violation rate of 3,000 VPH can be detected in fifty minutes, and a violation rate of 6,000 VPH can be detected in one hundred minutes on average. On rare occasions when the violation rate crosses the threshold, the sampling strategy is switched to a fixed rate so that the detection time remains bounded, but with an increased processing cost because the sampling budget effectively increases with the violation rate. Thus, for violation rates over 6,000 VPH, the sampling rate remains fixed at 1%, ensuring that the average detection time for a sampling-aware attack is around one hundred minutes. An exemplary implementation to adaptively sample security policy violations will now be discussed with respect to FIG. 7.

FIG. 7 is a flow diagram that illustrates an operation 700 of communication system 100. The operation 700 shown in FIG. 7 may also be referred to as adaptive sampling process 700 herein. The steps of the operation are indicated below parenthetically. The following discussion of operation 700 will proceed with reference to elements of FIG. 1 in order to illustrate its operations, but note that the details provided in FIG. 1 are merely exemplary and not intended to limit the scope of process 700 to the specific implementation shown in FIG. 1.

Operation 700 may be employed to facilitate adaptive sampling of security policy violations. As shown in the operational flow of FIG. 7, a variable sampling rate for sampling a fixed amount of security policy violation reports per unit time based on a violation rate is determined (701). Typically, the security policy violation reports may be transmitted by client web browsers 150, although the violation reports could be transmitted by other network elements in some examples. In at least one implementation, the security policy violation reports could comprise content security policy (CSP) violation reports. In some implementations, the variable sampling rate for sampling the fixed amount of security policy violation reports per unit time based on the violation rate could be determined by web server 130, submission server 140, or any other network elements or web application platform, such as a reverse proxy, load balancer, middleware, CDN, or any other system, device, or equipment involved in providing a web application to client web browsers 150, including combinations thereof. For example, submission server 140 could be configured to determine the variable sampling rate for sampling the fixed amount of security policy violation reports per unit time based on the violation rate in some implementations. Further, in at least one implementation, a security web module could be installed on web server 130 and implement the adaptive sampling techniques described herein. In this case, web server 130 may execute the security web module to determine the variable sampling rate for sampling the fixed amount of security policy violation reports per unit time based on the violation rate. For example, in response to page requests from client web browsers 150, web server 130 could determine the variable sampling rate for sampling the fixed amount of security policy violation reports per unit time based on the violation rate by probabilistically determining whether or not to include the ‘report-to’ reporting directive in security policy response headers to specify an endpoint where the security policy violation reports should be submitted. Further, because web server 130 may not have knowledge of the actual violation rate, web sever 130 could approximate the violation rate based on the traffic rate. Accordingly, in some implementations, the violation rate is approximated by the traffic. For example, in at least one implementation, web server 130 could determine the variable sampling rate for sampling the fixed amount of security policy violation reports per unit time based on the violation rate, wherein the violation rate is approximated by the traffic rate.

In at least one implementation, the fixed amount of security policy violation reports per unit time may be referred to as a sampling budget herein. In some implementations, the variable sampling rate may be determined by specifying a fixed sampling budget, such as a fixed amount of security policy violation reports per unit time. In at least one implementation, the sampling budget may be achieved by producing a violation rate-dependent variable sampling rate such that approximately the same amount of samples is generated per unit time, providing uniform visibility into the security policy violation reports across time. In at least one implementation, to determine the variable sampling rate for a current unit of time, such as one hour, a sliding window may be implemented using a specified time interval granularity of violation counts, such as minute-level. In this implementation, the variable sampling rate for the current time interval may be determined by the fraction of the sampling budget in the numerator over the violation rate in the denominator, where when a value of the fraction is greater than or equal to 1, then sample for the current time interval, and when the value of the fraction is less than 1, sample for the current time interval with a probability equal to the value of the fraction. Other techniques to determine the variable sampling rate for sampling the fixed amount of security policy violation reports per unit time based on the violation rate are possible and within the scope of this disclosure.

In some implementations, the sampling budget could be specified per context, such as a combination of page URL and user agent. In this implementation, the goal is to achieve is a fixed and uniform budget per combination of different contexts. For example, sample sixty violations every hour (equivalent to one per minute for uniformity) per combination of webpage URL and user agent. Accordingly, in at least one implementation, determining the variable sampling rate for sampling the fixed amount of the security policy violation reports per unit time based on the violation rate may comprise determining the variable sampling rate for sampling the fixed amount of the security policy violation reports per unit time for a set of combinations of page URL and user agent based on the violation rate. However, the number of potential contexts could be very high, and implementing the variable rate sampling may not be feasible over all possible combinations of contexts due to high memory requirements, so a hash function may be utilized to overcome the memory issue. Accordingly, in at least one implementation, values associated with the set of combinations of page URLs and user agents are tracked using a data structure of fixed size and retrieved by using a hash function. For example, an array of fixed size N may be used to store counters needed to generate the context-specific variable sampling rates. Then, for a web request (page URL, user agent), retrieve the counter values corresponding to the array index hash(page URL+user agent) mod N, where the operator+represents string concatenation, the operator mod represents modulo operation, and hash represents a string hashing function. Fixing the upper bound on the memory makes this approach practical, but it can lead to approximations that arise due to hash collisions.

The variable sampling rate is applied to sample the fixed amount of the security policy violation reports per unit time (702). In this manner, the fixed amount of the security policy violation reports per unit time is sampled according to the determined variable sampling rate. In at least one implementation, applying the variable sampling rate to sample the fixed amount of the security policy violation reports per unit time comprises applying the variable sampling rate by web server 130, in response to one or more page requests, to probabilistically specify at least one reporting directive in one or more responses based on the variable sampling rate in order to sample the fixed amount of the security policy violation reports per unit time. In some examples, the one or more responses could include response headers, and the at least one reporting directive could specify the URL of submission server 140. For example, in response to the page requests, web server 130 may implement adaptive sampling of the security policy violation reports by probabilistically determining whether or not to include the reporting directive in the response headers to specify an endpoint where the security policy violation reports should be submitted. Web server 130 then transmits the responses to the client web browsers 150, either with or without the reporting directive included according to the variable sampling rate. The client web browsers 150 then report any violations if submission server 140 was specified in the reporting directive in the response, but those client web browsers 150 that did not have the reporting directive included in their response will not report any violations, thereby implementing the variable sampling rate.

In some implementations, adaptive sampling of the security policy violation reports is implemented at submission server 140. Accordingly, in at least one implementation, applying the variable sampling rate to sample the fixed amount of the security policy violation reports per unit time comprises applying the variable sampling rate by submission server 140, in response to receiving the security policy violation reports, to probabilistically sample the fixed amount of the security policy violation reports per unit time based on the variable sampling rate. For example, submission server 140 could implement adaptive sampling of the security policy violation reports by probabilistically determining whether or not to sample the violations according to the variable sampling rate and the violation rate. In this manner, submission server 140 is able to apply more accurate sampling to generate the target variable sampling rate for sampling the fixed amount of the security policy violation reports per unit time.

When the violation rate exceeds a threshold, the variable sampling rate is switched to a fixed sampling rate for sampling a variable amount of the security policy violation reports per unit time (703). For example, in some implementations, submission server 140 could switch to a fixed sampling rate for sampling a variable amount of the security policy violation reports per unit time when the violation rate exceeds a threshold. In at least one implementation, web server 130 could approximate the violation rate by the traffic rate and switch to a fixed sampling rate for sampling a variable amount of the security policy violation reports per unit time when the violation rate exceeds a threshold. The amount of the security policy violation reports per unit time becomes variable after this point because the sampling rate is fixed, but the violation rate may continue to increase. In some examples, the threshold value is generally set for high levels of traffic volume or violation reports so that the detection time remains bounded after the volume crosses the threshold, but with an increased processing load because the sampling budget effectively increases with the violation rate after this point. In some implementations, the fixed sampling rate could be predetermined and may be correlated to the violation rate threshold.

The fixed sampling rate is applied to sample the variable amount of the security policy violation reports per unit time (704). In this manner, the variable amount of the security policy violation reports per unit time is sampled according to the fixed sampling rate. In at least one implementation, applying the fixed sampling rate to sample the variable amount of the security policy violation reports per unit time comprises applying the fixed sampling rate by web server 130, in response to one or more page requests, to probabilistically specify at least one reporting directive in one or more responses based on the fixed sampling rate in order to sample the variable amount of the security policy violation reports per unit time. In some examples, the one or more responses could include response headers, and the at least one reporting directive could specify the URL of submission server 140. For example, in response to the page requests, web server 130 may apply the fixed sampling rate to sample the variable amount of the security policy violation reports by utilizing the fixed sampling rate to probabilistically determine whether or not to include the reporting directive in the response headers to specify an endpoint where the security policy violation reports should be submitted. Web server 130 then transmits the responses to the client web browsers 150, either with or without the reporting directive included according to the fixed sampling rate. The client web browsers 150 then report any violations if submission server 140 was specified in the reporting directive in the response, but those client web browsers 150 that did not have the reporting directive included in their response will not report any violations, thereby effectively implementing the fixed sampling rate.

In some implementations, adaptive sampling of the security policy violation reports is implemented at submission server 140. Accordingly, in at least one implementation, applying the fixed sampling rate to sample the variable amount of the security policy violation reports per unit time comprises applying the fixed sampling rate by submission server 140, in response to receiving the security policy violation reports, to probabilistically sample the variable amount of the security policy violation reports per unit time based on the fixed sampling rate. For example, submission server 140 could apply the fixed sampling rate to sample the variable amount of the security policy violation reports by utilizing the fixed sampling rate to probabilistically determine whether or not to sample the violations according to the fixed sampling rate and the violation rate. In this manner, submission server 140 is able to apply more accurate sampling to generate the target fixed sampling rate for sampling the variable amount of the security policy violation reports per unit time.

Advantageously, adaptive sampling process 700 is operable to minimize the number of security policy violation reports so that security administrators are able to analyze the violation reports and respond in an expected time frame, while providing improved visibility of policy violations by delivering a uniform number of samples per unit time. Adaptive sampling of security policy violation reports achieves an improvement in both utility and security by providing continuous and uniform visibility across time needed to detect attacks in a timely manner, while also reducing the processing cost associated with managing and responding to the violations. Further, a space-efficient adaptive sampling algorithm may be employed to extend the uniformity across other contexts associated with web requests, such as page URLs and user agents. In this manner, the adaptive sampling techniques disclosed herein provide a powerful tool for controlling the effective sampling rate that optimizes the resource utilization.

Now referring back to FIG. 1, web resources 110 and communication network 120 communicate over communication link 111, web server 130 and communication network 120 communicate over communication link 112, submission server 140 and communication network 120 communicate over communication link 113, and client web browsers 150 and communication network 120 communicate over communication link 114. In some examples, web server 130 could comprise a web server, CDN, reverse proxy, load balancer, or any other computing system or network equipment. In at least one implementation, web server 130 could comprise a system that provides a cloud-based web service. In some implementations, web resources 110 could comprise any resources used in the provision of a web application, such as scripts, code libraries, fonts, JavaScript files, images, and any other web application components, which may be stored on a database or some other data storage system that provides web resources 110 for a web application. In at least one implementation, web resources 110 could be part of an origin web server that provides a web application, which may include internal inline scripts that are embedded into hypertext markup language (HTML) pages, but web resources 110 could also represent first party web resources of the web application owner that are provided via CDNs and other external data sources. Additionally or alternatively, web resources 110 could also represent external web resources that are provided by third parties, such as advertisers or external libraries, which would also be served by external data sources.

Web server 130 may be representative of any computing apparatus, system, or systems that may connect to another computing system over a communication network. Web server 130 comprises a processing system and communication transceiver. Web server 130 may also include other components such as a router, server, data storage system, and power supply. Web server 130 may reside in a single device or may be distributed across multiple devices. Web server 130 may be a discrete system or may be integrated within other systems, including other systems within communication system 100. Some examples of web server 130 include database systems, desktop computers, server computers, cloud computing platforms, and virtual machines, as well as any other type of computing system, variation, or combination thereof In some examples, web server 130 could comprise a network security appliance, firewall, CDN, reverse proxy, load balancer, middleware, cloud server, intrusion prevention system, web application firewall, web server, network switch, router, switching system, packet gateway, network gateway system, Internet access node, application server, database system, service node, or some other communication system, including combinations thereof

Submission server 140 may be representative of any computing apparatus, system, or systems that may connect to another computing system over a communication network. Submission server 140 comprises a processing system and communication transceiver. Submission server 140 may also include other components such as a router, server, data storage system, and power supply. Submission server 140 may reside in a single device or may be distributed across multiple devices. Submission server 140 may be a discrete system or may be integrated within other systems, including other systems within communication system 100. Some examples of submission server 140 include database systems, desktop computers, server computers, cloud computing platforms, and virtual machines, as well as any other type of computing system, variation, or combination thereof. In some examples, submission server 140 could comprise a network security appliance, firewall, CDN, reverse proxy, load balancer, middleware, cloud server, intrusion prevention system, web application firewall, web server, network switch, router, switching system, packet gateway, network gateway system, Internet access node, application server, database system, service node, or some other communication system, including combinations thereof.

Client web browsers 150 are loaded on executed on various computing systems, including any computing apparatus, system, or systems that may connect to another computing system over a communication network. A representative computing system comprises a processing system and communication transceiver. A representative computing system may also include other components such as a router, server, data storage system, and power supply. The computing system could reside in a single device or may be distributed across multiple devices, and may be a discrete system or could be integrated within other systems, including other systems within communication system 100. Some examples of representative computing systems include desktop computers, server computers, cloud computing platforms, and virtual machines, as well as any other type of computing system, variation, or combination thereof In some examples, the computing system could comprise a web server, CDN, reverse proxy, load balancer, middleware, cloud server, network switch, router, switching system, packet gateway, network gateway system, Internet access node, application server, database system, service node, firewall, or some other communication system, including combinations thereof.

Web resources 110 may be provided by any computing apparatus, system, or systems that may connect to another computing system over a communication network. Web resources 110 may be provided by systems that could comprise a data storage system and communication transceiver. Web resources 110 may be provided by systems that could also include other components such as a processing system, router, server, and power supply. Web resources 110 may reside in a single device or may be distributed across multiple devices. Web resources 110 may be provided by a discrete system or may be provided by multiple systems, including other systems within communication system 100. Some examples of systems that may provide web resources 110 include database systems, desktop computers, server computers, cloud computing platforms, and virtual machines, as well as any other type of computing system, variation, or combination thereof. In some examples, web resources 110 could be provided by a web server, CDN, reverse proxy, load balancer, middleware, cloud server, network security appliance, firewall, intrusion prevention system, network switch, router, switching system, packet gateway, network gateway system, Internet access node, application server, database system, service node, or some other communication system, including combinations thereof.

Communication network 120 could comprise multiple network elements such as routers, gateways, telecommunication switches, servers, processing systems, or other communication equipment and systems for providing communication and data services. In some examples, communication network 120 could comprise wireless communication nodes, telephony switches, Internet routers, network gateways, computer systems, communication links, or some other type of communication equipment, including combinations thereof. Communication network 120 may also comprise optical networks, packet networks, local area networks (LAN), metropolitan area networks (MAN), wide area networks (WAN), or other network topologies, equipment, or systems, including combinations thereof. Communication network 120 may be configured to communicate over wired or wireless communication links. Communication network 120 may be configured to use Internet Protocol (IP), Ethernet, optical networking, wireless protocols, communication signaling, or some other communication format, including combinations thereof. In some examples, communication network 120 includes further access nodes and associated equipment for providing communication services to several computer systems across a large geographic region.

Communication links 111-114 use metal, air, space, optical fiber such as glass or plastic, or some other material as the transport medium, including combinations thereof. Communication links 111-114 could use various communication protocols, such as IP, Ethernet, optical networking, hybrid fiber coax (HFC), communication signaling, wireless protocols, or some other communication format, including combinations thereof. Communication links 111-114 could be direct links or may include intermediate networks, systems, or devices.

Turning now to FIG. 8, a block diagram is shown that illustrates computing system 800 in an exemplary implementation. Computing system 800 provides an example of web server 130, submission server 140, or any computing system that may be used to execute adaptive sampling process 200 or variations thereof, although web server 130 and submission server 140 could use alternative configurations. Computing system 800 includes processing system 801, storage system 803, software 805, communication interface 807, and user interface 809. User interface 809 comprises display system 808. Software 805 includes application 806 which itself includes adaptive sampling process 200. Adaptive sampling process 200 may optionally be implemented separately from application 806, as indicated by the dashed line in FIG. 8.

Computing system 800 may be representative of any computing apparatus, system, or systems on which application 806 and adaptive sampling process 200 or variations thereof may be suitably implemented. Examples of computing system 800 include mobile computing devices, such as cell phones, tablet computers, laptop computers, notebook computers, and gaming devices, as well as any other type of mobile computing devices and any combination or variation thereof. Note that the features and functionality of computing system 800 may apply as well to desktop computers, server computers, and virtual machines, as well as any other type of computing system, variation, or combination thereof.

Computing system 800 includes processing system 801, storage system 803, software 805, communication interface 807, and user interface 809. Processing system 801 is operatively coupled with storage system 803, communication interface 807, and user interface 809. Processing system 801 loads and executes software 805 from storage system 803. When executed by computing system 800 in general, and processing system 801 in particular, software 805 directs computing system 800 to operate as described herein for adaptive sampling process 200 or variations thereof. Computing system 800 may optionally include additional devices, features, or functionality not discussed herein for purposes of brevity.

Referring still to FIG. 8, processing system 801 may comprise a microprocessor and other circuitry that retrieves and executes software 805 from storage system 803. Processing system 801 may be implemented within a single processing device but may also be distributed across multiple processing devices or sub-systems that cooperate in executing program instructions. Examples of processing system 801 include general purpose central processing units, application specific processors, and logic devices, as well as any other type of processing device, combinations, or variations thereof

Storage system 803 may comprise any computer-readable storage media capable of storing software 805 and readable by processing system 801. Storage system 803 may include volatile and nonvolatile, removable and non-removable media implemented in any method or technology for storage of information, such as computer readable instructions, data structures, program modules, or other data. Storage system 803 may be implemented as a single storage device but may also be implemented across multiple storage devices or sub-systems co-located or distributed relative to each other. Storage system 803 may comprise additional elements, such as a controller, capable of communicating with processing system 801. Examples of storage media include random-access memory, read-only memory, magnetic disks, optical disks, flash memory, virtual memory and non-virtual memory, magnetic cassettes, magnetic tape, magnetic disk storage or other magnetic storage devices, or any other medium which can be used to store the desired information and that may be accessed by an instruction execution system, as well as any combination or variation thereof, or any other type of storage media. In no case is the computer-readable storage media a propagated signal.

In operation, processing system 801 may load and execute portions of software 805, such as adaptive sampling process 200, to operate as described herein for adaptive sampling process 200 or variations thereof. Software 805 may be implemented in program instructions and among other functions may, when executed by computing system 800 in general or processing system 801 in particular, direct computing system 800 or processing system 801 to determine a variable sampling rate for sampling a fixed amount of security policy violation reports per unit time based on a violation rate. Software 805 may further direct computing system 800 or processing system 801 to apply the variable sampling rate to sample the fixed amount of the security policy violation reports per unit time. In addition, software 805 directs computing system 800 or processing system 801 to, when the violation rate exceeds a threshold, switch to a fixed sampling rate for sampling a variable amount of the security policy violation reports per unit time. Software 805 may further direct computing system 800 or processing system 801 to apply the fixed sampling rate to sample the variable amount of the security policy violation reports per unit time.

Software 805 may include additional processes, programs, or components, such as operating system software or other application software. Examples of operating systems include Windows®, iOS®, and Android®, as well as any other suitable operating system. Software 805 may also comprise firmware or some other form of machine-readable processing instructions executable by processing system 801.

In general, software 805 may, when loaded into processing system 801 and executed, transform computing system 800 overall from a general-purpose computing system into a special-purpose computing system customized to facilitate adaptive sampling of security policy violations as described herein for each implementation. For example, encoding software 805 on storage system 803 may transform the physical structure of storage system 803. The specific transformation of the physical structure may depend on various factors in different implementations of this description. Examples of such factors may include, but are not limited to the technology used to implement the storage media of storage system 803 and whether the computer-storage media are characterized as primary or secondary storage.

In some examples, if the computer-storage media are implemented as semiconductor-based memory, software 805 may transform the physical state of the semiconductor memory when the program is encoded therein. For example, software 805 may transform the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate this discussion.

It should be understood that computing system 800 is generally intended to represent a computing system with which software 805 is deployed and executed in order to implement application 806 and/or adaptive sampling process 200 (and variations thereof). However, computing system 800 may also represent any computing system on which software 805 may be staged and from where software 805 may be distributed, transported, downloaded, or otherwise provided to yet another computing system for deployment and execution, or yet additional distribution. For example, computing system 800 could be configured to deploy software 805 over the internet to one or more client computing systems for execution thereon, such as in a cloud-based deployment scenario.

Communication interface 807 may include communication connections and devices that allow for communication between computing system 800 and other computing systems (not shown) or services, over a communication network 811 or collection of networks. In some implementations, communication interface 807 receives dynamic data 821 over communication network 811. Examples of connections and devices that together allow for inter-system communication may include network interface cards, antennas, power amplifiers, RF circuitry, transceivers, and other communication circuitry. The aforementioned network, connections, and devices are well known and need not be discussed at length here.

User interface 809 may include a voice input device, a touch input device for receiving a gesture from a user, a motion input device for detecting non-touch gestures and other motions by a user, and other comparable input devices and associated processing elements capable of receiving user input from a user. Output devices such as display system 808, speakers, haptic devices, and other types of output devices may also be included in user interface 809. The aforementioned user input devices are well known in the art and need not be discussed at length here. User interface 809 may also include associated user interface software executable by processing system 801 in support of the various user input and output devices discussed above. Separately or in conjunction with each other and other hardware and software elements, the user interface software and devices may provide a graphical user interface, a natural user interface, or any other kind of user interface. User interface 809 may be omitted in some examples.

The functional block diagrams, operational sequences, and flow diagrams provided in the Figures are representative of exemplary architectures, environments, and methodologies for performing novel aspects of the disclosure. While, for purposes of simplicity of explanation, methods included herein may be in the form of a functional diagram, operational sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method to adaptively sample security policy violations, the method comprising:
determining a variable sampling rate for sampling a fixed amount of security policy violation reports per unit time based on a violation rate;
applying the variable sampling rate to sample the fixed amount of the security policy violation reports per unit time;
when the violation rate exceeds a threshold, switching to a fixed sampling rate for sampling a variable amount of the security policy violation reports per unit time; and
applying the fixed sampling rate to sample the variable amount of the security policy violation reports per unit time.

2. The method of claim 1 wherein applying the variable sampling rate to sample the fixed amount of the security policy violation reports per unit time comprises applying the variable sampling rate by a web server, in response to one or more page requests, to probabilistically specify at least one reporting directive in one or more responses based on the variable sampling rate in order to sample the fixed amount of the security policy violation reports per unit time.

3. The method of claim 1 wherein applying the variable sampling rate to sample the fixed amount of the security policy violation reports per unit time comprises applying the variable sampling rate by a submission server, in response to receiving the security policy violation reports, to probabilistically sample the fixed amount of the security policy violation reports per unit time based on the variable sampling rate.

4. The method of claim 1 wherein determining the variable sampling rate for sampling the fixed amount of the security policy violation reports per unit time based on the violation rate comprises determining the variable sampling rate for sampling the fixed amount of the security policy violation reports per unit time for a set of combinations of page uniform resource locator (URL) and user agent based on the violation rate.

5. The method of claim 4 wherein values associated with the set of combinations of page URL and user agent are tracked using a data structure of fixed size and retrieved by using a hash function.

6. The method of claim 1 wherein the violation rate is approximated by the traffic rate.

7. The method of claim 1 wherein the security policy violation reports comprise content security policy (CSP) violation reports.

8. One or more computer-readable storage media having program instructions stored thereon to facilitate adaptive sampling of security policy violations, wherein the program instructions, when executed by a computing system, direct the computing system to perform operations, the operations comprising:
determining a variable sampling rate for sampling a fixed amount of security policy violation reports per unit time based on a violation rate;
applying the variable sampling rate to sample the fixed amount of the security policy violation reports per unit time;
when the violation rate exceeds a threshold, switching to a fixed sampling rate for sampling a variable amount of the security policy violation reports per unit time; and
applying the fixed sampling rate to sample the variable amount of the security policy violation reports per unit time.

9. The one or more computer-readable storage media of claim 8 wherein the computing system comprises a web server, and wherein applying the variable sampling rate to sample the fixed amount of the security policy violation reports per unit time comprises applying the variable sampling rate by the web server, in response to one or more page requests, to probabilistically specify at least one reporting directive in one or more responses based on the variable sampling rate in order to sample the fixed amount of the security policy violation reports per unit time.

10. The one or more computer-readable storage media of claim 8 wherein the computing system comprises a submission server, and wherein applying the variable sampling rate to sample the fixed amount of the security policy violation reports per unit time comprises applying the variable sampling rate by the submission server, in response to receiving the security policy violation reports, to probabilistically sample the fixed amount of the security policy violation reports per unit time based on the variable sampling rate.

11. The one or more computer-readable storage media of claim 8 wherein determining the variable sampling rate for sampling the fixed amount of the security policy violation reports per unit time based on the violation rate comprises determining the variable sampling rate for sampling the fixed amount of the security policy violation reports per unit time for a set of combinations of page uniform resource locator (URL) and user agent based on the violation rate.

12. The one or more computer-readable storage media of claim 11 wherein values associated with the set of combinations of page URL and user agent are tracked using a data structure of fixed size and retrieved by using a hash function.

13. The one or more computer-readable storage media of claim 8 wherein the violation rate is approximated by the traffic rate.

14. The one or more computer-readable storage media of claim 8 wherein the security policy violation reports comprise content security policy (CSP) violation reports.

15. An apparatus to facilitate adaptive sampling of security policy violations, the apparatus comprising:
one or more computer-readable storage media;
a processing system operatively coupled with the one or more computer-readable storage media; and
program instructions stored on the one or more computer-readable storage media that, when executed by the processing system, direct the processing system to perform operations, the operations comprising:
determining a variable sampling rate for sampling a fixed amount of security policy violation reports per unit time based on a violation rate;
applying the variable sampling rate to sample the fixed amount of the security policy violation reports per unit time;
when the violation rate exceeds a threshold, switching to a fixed sampling rate for sampling a variable amount of the security policy violation reports per unit time; and
applying the fixed sampling rate to sample the variable amount of the security policy violation reports per unit time.

16. The apparatus of claim 15 wherein applying the variable sampling rate to sample the fixed amount of the security policy violation reports per unit time comprises, in response to one or more page requests, applying the variable sampling rate to probabilistically specify at least one reporting directive in one or more responses based on the variable sampling rate in order to sample the fixed amount of the security policy violation reports per unit time.

17. The apparatus of claim 15 wherein applying the variable sampling rate to sample the fixed amount of the security policy violation reports per unit time comprises, in response to receiving the security policy violation reports, applying the variable sampling rate to probabilistically sample the fixed amount of the security policy violation reports per unit time based on the variable sampling rate.

18. The apparatus of claim 15 wherein determining the variable sampling rate for sampling the fixed amount of the security policy violation reports per unit time based on the violation rate comprises determining the variable sampling rate for sampling the fixed amount of the security policy violation reports per unit time for a set of combinations of page uniform resource locator (URL) and user agent based on the violation rate.

19. The apparatus of claim 18 wherein values associated with the set of combinations of page URL and user agent are tracked using a data structure of fixed size and retrieved by using a hash function.

20. The apparatus of claim 15 wherein the violation rate is approximated by the traffic rate.
